(19) United States
(12) Patent Application Publication
(10) Pub. No.: US 2007/0260379 A1
(43) Pub. Date: Nov. 8, 2007

(54) Method of operating a machine for conditioning a work material

(76) Inventor: Thomas M. Congdon, Dunlap, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/418,926

(22) Filed: May 5, 2006

(51) Int. Cl. G06F 19/00

(52) U.S. Cl. 701/50

(57) ABSTRACT

A machine, such as a scraper machine, is configured to transport a work material from a first work area to a second work area, and includes a substance condition sensor configured to sense the relative amount of a desired substance, such as water, during real time operation of the machine. The machine may further include a work material conditioning apparatus having a substance dispenser connected with a substance storage tank mounted on the machine, and configured to dispense the desired substance to the work material responsive to a signal from the sensor associated with a relative moisture content of work material within the machine.

### TECHNICAL FIELD

The present disclosure relates generally to conditioning work materials such as soil and the like, and relates more particularly to an operating method for a machine, such as a scraper, that includes adding a desired substance responsive to a sensed content of the substance in the work material.

### BACKGROUND

Many different construction, mining, materials treatment and work site preparation projects involve the transportation of relatively large volumes of material. In most highway construction projects, for example, an underlying layer or “lift” composed of properly prepared and conditioned work material must typically be provided before paving work can begin if an acceptable end quality of the project is to result. One characteristic that is often of significant importance in achieving acceptable or superior results in paving and certain other work projects relates to the moisture content of the work material. In compaction operations in particular, the use of soil with a proper moisture content may be critical in complying with jurisdictional compaction specifications. Because moisture in work materials such as soil and the like tends to lubricate the material particles, the presence of sufficient moisture content can generally allow the material to be compacted to a suitable level more efficaciously than when the material is too dry. Soil moisture, however, tends to be difficult to control in process, and frequently requires rework after the lift has been placed.

In a typical construction project such as road building, deposited work material may be subjected to various in situ procedures to adjust the moisture content toward a desired content. Where deposited lift is determined to be too dry, for example, a water truck may be driven across the work surface and an estimated or calculated necessary quantity of water applied via a sprayer. Lift that is overly wet, on the other hand, may be conditioned by disking or tilling to hasten drying. In an ideal situation, such procedures are actually followed to condition lift to the proper moisture content prior to compaction, paving, etc. In many instances, however, the soil is compacted and paved without properly determining and adjusting the moisture content.

Other substance content concerns are attendant to different types of work projects. For example, certain work materials may be conditioned to have a desired pH, for example by adjusting a lime content of the material. In certain agricultural practices, soil chemical conditions may be measured for a given area of a field, and materials added in situ to bring the soil up to specifications without moving it from place to place. Regardless of the material type and particular project, however, it will be readily apparent that processing work material after deposition in many work projects can be quite time consuming and expensive, and even modest improvements in processing efficiency can result in substantial economic savings.

The above shortcomings of in situ work material preparation have long been recognized by those involved in construction, paving, earthmoving and related fields. In U.S. Pat. No. 5,199,196 to Straley, a soil compaction tractor having water spray capability is disclosed. Straley recognizes that achieving an optimum moisture content for soil to be compacted is desirable. To this end, the Straley design includes a hydraulically operated bucket mounted on a tractor with a spray nozzle positioned on the bucket. The spray nozzle is used to spray water onto work material to adjust its moisture content, either when the material is in the bucket or outside of the bucket. While Straley might provide advantages over certain earlier approaches, the system appears to require an operator or technician's subjective determination of when and how much water to apply to the soil. Moreover, loader-equipped tractors such as that used in Straley are limited in their capacity to efficiently move relatively large quantities of work material from the immediate work site, requiring a separate truck for this purpose.

The present disclosure is directed to one or more of the problems or shortcomings set forth above.

### SUMMARY OF THE INVENTION

In one aspect, the present disclosure provides a method of operating a scraper machine. The method includes the steps of trans porting work material from a first work area to a second work area, sensing a parameter value indicative of a desired substance content in at least a portion of the work material with a sensor of the scraper machine, and generating a signal with the sensor.

In another aspect, the present disclosure provides a method of operating a machine. The method includes the steps of transporting work material from a first work area to a second work area with the machine, and sensing a parameter value indicative of a desired substance content in at least a portion of the work material. The method further includes the step of conditioning at least a portion of the work material with a conditioning apparatus of the machine, including dispensing the desired substance to the work material responsive to the sensed parameter value.

In still another aspect, the present disclosure provides a scraper machine, including a substance storage tank and a bowl mounted on a frame, and a work material conditioning apparatus. The work material conditioning apparatus includes a substance condition sensor configured to output a signal associated with a relative content of the substance in a work material, and a substance dispenser connected to the substance storage tank and configured to selectively dispense the substance to at least a portion of work material within the scraper machine responsive to the signal.

### BRIEF DESCRIPTION OF THE DRAWINGS

FIG. 1 is a partially open side view of a scraper machine according to the present disclosure;

FIG. 2 is a diagrammatic view of a portion of a machine similar to the machine shown in FIG. 1; and

FIG. 3 is a flowchart illustrating a process according to the present disclosure.

### DETAILED DESCRIPTION

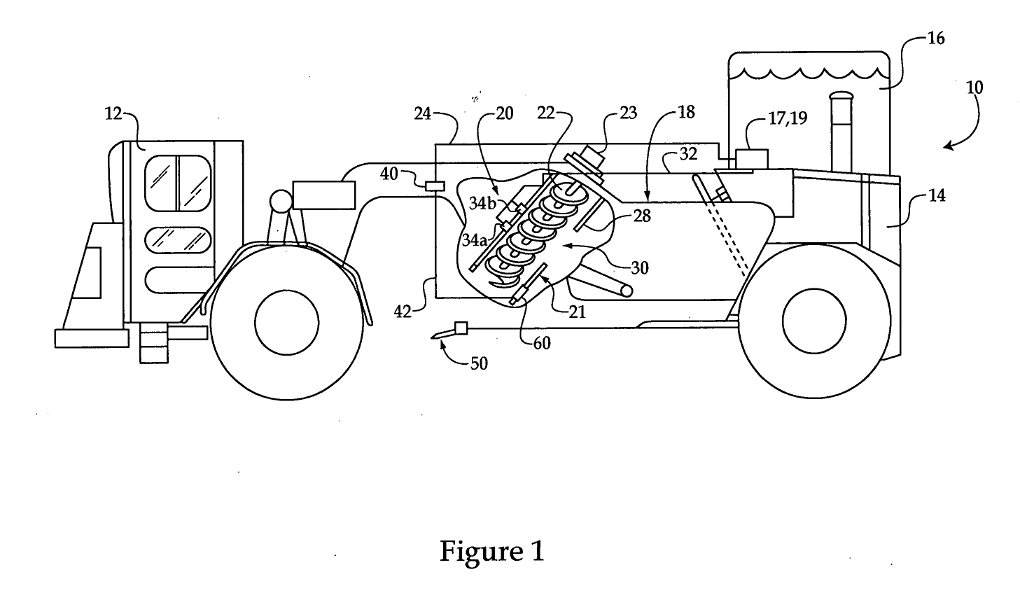

Referring to FIG. 1, there is shown a machine 10 according to the present disclosure. Machine 10 is shown in the context of a self-propelled articulated scraper machine such as are commonly used for transporting work material between different work areas, for example, different areas of a construction site, or different construction sites altogether. It should be appreciated that machines other than self-propelled scrapers are contemplated within the context of the present disclosure, however. For example, tow-behind and pushed scrapers, and non-articulated scrapers are contemplated herein. Further, machine 10 might be configured as an attachment to another mobile machine, and in some embodiments might comprise a stationary unit, with work material transported to and from the stationary unit or between different work areas by other machines. In all contemplated embodiments, however, machine 10 will be configured to sense a relative substance content of a desired substance in a work material, and in certain embodiments will be configured to condition the work material by selectively adding the desired substance, as described herein.

Returning to the context of an articulated scraper, machine 10 may include an articulated frame having a front frame unit 12 and a back frame unit 14. A cutter 50 may be coupled with back frame unit 14 and movable to a desired cutting depth in a work material. Positioning cutter 50 at the desired cutting depth and moving machine 10 through a work material will allow work material to be captured and moved within machine 10 to a receptacle such as a bowl 18 or the like, and conditioned within machine 10 in the manner described herein. Once a desired quantity of work material is captured, conditioned, etc., cutter 50 may be moved to an upward position, approximately as shown in FIG. 1, and the captured work material transported to another work area for eventual disposition.

Unloading of the work material transported by machine 10 may take place in a manner similar to that associated with conventional scraper machines, i.e. by again lowering cutter 50 to a desired position and ejecting material from bowl 18 at a desired lift thickness while machine 10 is driven in a forward direction. Those skilled in the art will appreciate that for different machine types, capturing and deposition of work material may take place in a wide variety of ways, and may even employ additional machines. In some embodiments, however, machine 10 will be configured to independently perform all the functions of a particular capture, sensing, conditioning and deposition work cycle.

A work material conditioning apparatus 20 may further be provided for conditioning work material within machine 10, as described herein, and mounted for example to back frame unit 14. Machine 10 may also include a loading apparatus 21 that is part of or separate from work material conditioning apparatus 20 and configured to move work material within machine 10 between cutter 50 and bowl 18. Work material conditioning apparatus 20 may be configured to condition work material within machine 10 during either or both of loading and unloading work material from bowl 18 with loading apparatus 21. In alternative embodiments, conditioning apparatus 20 might be configured to condition work material within machine 10 after the work material has been loaded, but prior to unloading.

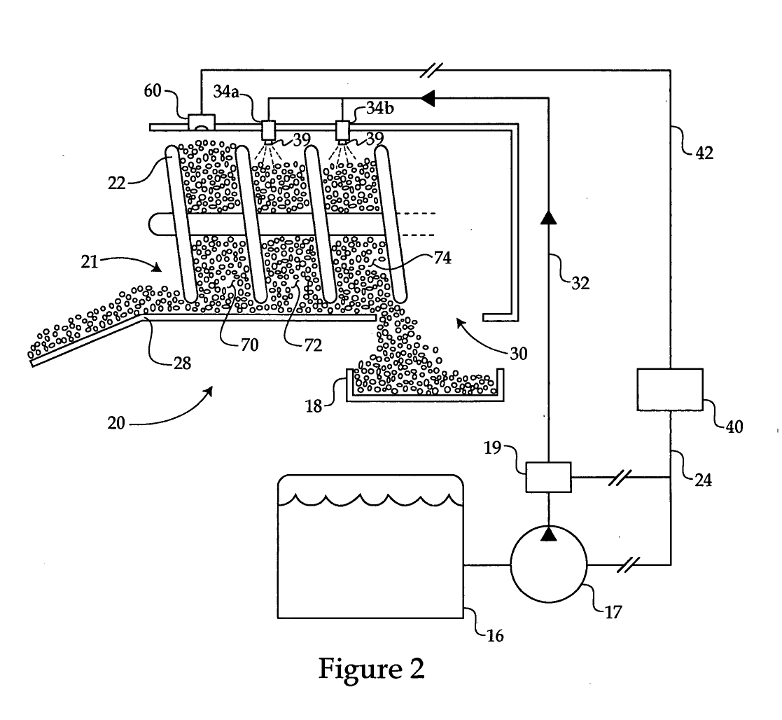

Referring also to FIG. 2, there is shown a diagrammatic illustration including a work material conditioning apparatus 20 suitable for use with machine 10 of FIG. 1, and a material receptacle 18, similar to bowl 18 of machine 10. Apparatus 20 may include a loading apparatus 21 having a material feed implement 22 disposed at least partially within a housing 28. Material feed implement 22 may include at least one auger 22, for example two augers 22, rotatable via a motor 23 to move work material from housing 28 to receptacle 18 via a discharge opening 30 in housing 28. In one embodiment, loading apparatus 21 may comprise first and second, counter-rotating augers oriented in parallel, although in other embodiments a single auger, a material elevator, or some other loading and/or unloading apparatus altogether may be used. For ease of description operation of a single auger/implement 22 is set forth herein.

Implement 22 may be rotated in a first direction to move work material through housing 28 and into receptacle 18, and may be reversed to move work material in an opposite direction from receptacle 18 through housing 28. In the context of a scraper machine such as machine 10, a material ejector or the like may be employed to assist implement 22 in moving work material from receptacle 18 through housing 28, and out of machine 10 for deposition.

It should be appreciated that the term “condition” in reference to work material herein should be understood to mean that at least one substance may be added to the work material, the relative content of the at least one substance in the work material being sensed via apparatus 20 in a manner described herein. The work material may be further conditioned by mixing, and/or by adding more than one substance thereto if desired.

Apparatus 20 may thus include a substance condition sensor 60 positioned at least partially within housing 28 and configured to generate and output a signal via a communication line 42 to an electronic controller 40. The substance condition sensor 60 may be configured to output a signal which is associated with a relative content of a desired substance in a work material. Apparatus 20 may further include a substance storage tank 16 such as a fluid storage tank mounted on back frame unit 14, and at least one substance dispenser.

The at least one substance dispenser may include first and second substance dispensers 34a and 34b, connected to substance storage tank 16 via a supply line 32, and configured to selectively dispense the substance stored in the tank to at least a portion of work material within machine 10, for example, a portion of the work material within housing 28. Dispensing of the desired substance may take place via a control signal from electronic controller 40 generated responsive to the signal outputted from sensor 60, as described herein.

In one embodiment, dispensers 34a and 34b may comprise conventional fluid spray nozzles having tips 39 extending at least partially into housing 28 such that they can spray the desired substance onto and/or into the work material therein. A pump 17 and metering valve 19 may further be provided for facilitating delivery of a fluid containing the substance of interest from tank 16 to dispensers 34a and 34b, pump 17 and valve 19 being coupled with electronic controller 40 via a communication line 24, for example.

It is contemplated that relative moisture content of soil or another work material may be sensed via sensor 60 in real time, and water or another fluid may be selectively dispensed via dispensers 34a and 34b in response to the sensed moisture content. To this end, sensor 60 may comprise a near infrared reflectance spectrophotometer, of the type available from Analytical Spectral Devices, Inc. of Boulder, Colo., or sensor 60 may comprise a different type of moisture sensor. Sensing of relative moisture allows work material that is too dry, or too wet, to be identified prior to deposition.

If at least a portion of the work material load in machine 10 is too dry, it may be identified and water added prior to deposition. If the moisture content is either too high, or too low, preparations at the work site where material is to be deposited may be taken. For example, an operator or automated signaling device may communicate in advance the sensed work material state, and appropriate machinery such as a water truck or disk-equipped tractor dispatched, loaded, etc. in advance of the arrival of the work material load. With overly wet work material, machine 10 could be parked to allow drying to ambient prior to deposition. Even where the moisture content of the entire load is optimal, by alerting personnel to such effect the present disclosure can improve efficiency by allowing site operators to focus their attention and resources on other parts of the work site, or on other loads of arriving work material which may need attention.

In certain embodiments, rather than spraying a fluid onto or into work material with apparatus 20, a granular mixture such as lime, a slurry, or some other material phase or composition such as a soil stabilizer might be dispensed with apparatus 20. Dispensing may also be provided by means other than a spray nozzle, such as a separate feed auger or conveyor. Where lime content or pH is a parameter of interest in conditioning work material with apparatus 20, sensor 60 could comprise a pH sensor, and dispensers 34a and 34b could be granulated lime or slurried lime dispensers. Still further embodiments might comprise machines equipped with more than one type of sensor, and more than one type of substance storage tank, capable of sensing and remedying a plurality of work material conditions and/or defects.

### INDUSTRIAL APPLICABILITY

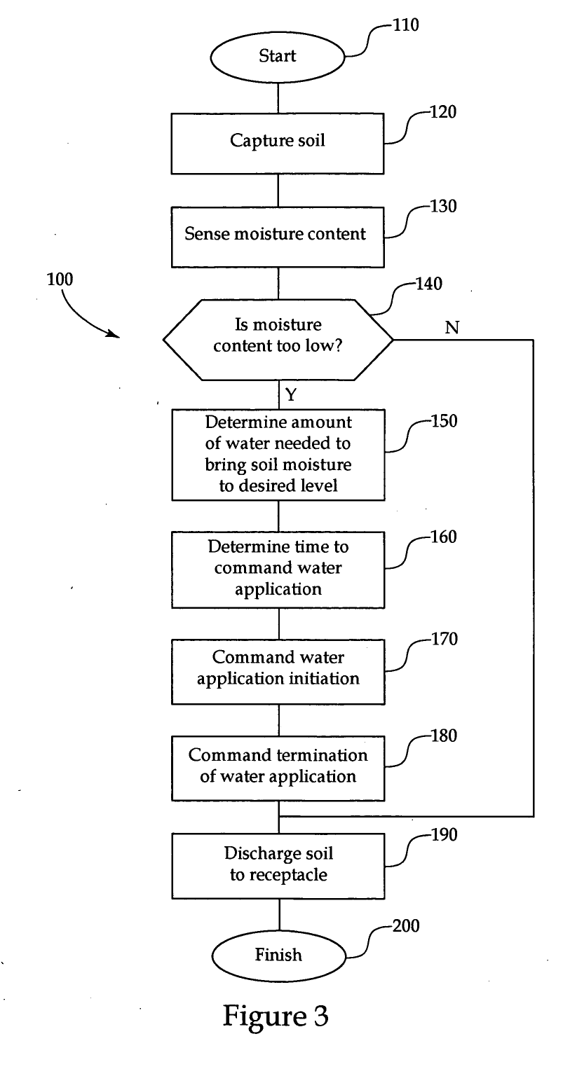

A work cycle according to one embodiment of the present disclosure may be initiated by driving machine 10 across a work surface at a first work area, and lowering cutter 50 to a desired cutting depth to move cutter 50 through work material. Forward motion of machine 10 will allow cutter 50 to capture work material and urge the same toward conditioning apparatus 20 and loading apparatus 22. Once work material is captured, conditioning of the same may begin. Referring to FIG. 3, there is shown a flowchart 100 illustrating an exemplary process that includes conditioning the moisture of a work material such as soil in accordance with one embodiment of the present disclosure. Process 100 begins at Step 110, corresponding to a START, and may then proceed to Step 120 wherein soil or another work material is captured as described herein, or otherwise loaded into conditioning apparatus 20.

The process may then proceed to Step 130 wherein sensor 60 will sense moisture content in the portion of work material in a space 70 defined in part by housing 28, and in part by implement 22, for example. Work material may be moved through housing 28 by rotating implement 22 in the illustrated embodiment, and may be moved such that a portion of the work material slides past sensor 60 and contacts or approaches the same. From Step 130, the process may proceed to Step 140 wherein electronic controller 40 may determine whether the moisture content of the sensed portion of work material in space 70 is too low, for example, responsively to a signal outputted by sensor 60 to electronic controller 40 associated with Step 130. If the moisture content is too low, the process may proceed ahead to Step 190 wherein the soil is discharged to receptacle 18. If the determined moisture content of the sensed volume of work material is less than a desired content at Step 140, the process may proceed to Step 150 wherein electronic controller 40 may determine the amount of water or water containing fluid to dispense to the portion of soil whose moisture content is sensed in Step 130.

It should be appreciated that the “content” of moisture in the work material may be a relative volume of moisture in a given volume of work material. In the embodiment of FIGS. 1 and 2, an approximate volume of work material whose moisture content is being sensed at any one time may be that work material in space 70. Where the approximate volume of space 70 is known, the signal from sensor 60 that is associated with moisture content may be used by electronic controller 40 to calculate or otherwise determine a volume of water or other fluid that is to be added, if necessary, to bring the moisture content of the subject volume of soil to a desired level.

Those skilled in the art will appreciate that rather than volume, some other factor such as work material mass or weight might be used to determine a corresponding mass, weight or volume of water that is to be added. It will further be appreciated that electronic controller 40 need not be configured to actually calculate the amount of water, other fluid, etc. that is to be added, but could instead reference a look-up table or the like to determine an appropriate amount of water to add for a given moisture content signal from sensor 60.

From Step 150, the process may proceed to Step 160 wherein electronic controller 40 may determine the time to command water application to the portion of soil via at least one of dispensers 34a and 34b. Rotation of implement 22 will progressively feed work material through housing 28, and thus work material whose moisture content is sensed by sensor 60 will in most embodiments not be appropriately positioned for conditioning by dispensers 34a and 34b until it is moved slightly past sensors 60. To this end, electronic controller 40 may be configured to delay adding water to the work material until a time increment has elapsed which is sufficient for work material to be moved from space 70 to one or more additional spaces 72 and 74 such that the portion of work material whose moisture content is sensed may be sprayed via dispenser 34a, and dispenser 34b if desired. Those skilled in the art will appreciate that the relative timing of activating pump 17 and/or valve 19 to allow spraying of water into spaces 72 and/or 74, may depend upon the rotational speed of implement 22 and hence the loading rate of loading apparatus 21. The rotational speed of implement 22 may be variable and thus affect the timing of adding water via dispensers 34a and 34b. A response time of pump 17, valve 19, for example, may also affect the relative timing of spraying. While continuously moving work material through housing 28 will provide one practical implementation strategy, the present disclosure is not limited as such. In other embodiments, a given volume of work material could be conditioned via sensing and dispensing of water, etc. while it is not being actively loaded or unloaded from machine 10. Further still, work material in machine 10 need not be conditioned in discrete portions, but instead the entire material load carried by machine 10 could be conditioned at once, for instance, during transporting between work areas.

Returning to the process of flowchart 100, from Step 160, the process may proceed to Step 170 wherein electronic controller 40 may command initiation of water application via control signals to pump 17 and metering valve 19 to supply water to dispensers 34a and 34b and spray it onto the work material at the desired time. From Step 170, the process may proceed to Step 180 wherein electronic controller 40 will command termination of water application by dispensers 34a and 34b, and thenceforth to Step 190 wherein soil may be discharged to receptacle 18. The process may then proceed to Step 200 to FINISH, or repeat.

It will be apparent from the above description that conditioning apparatus 20 may be configured to sense the moisture content of a given volume of work material, adjust its moisture content, then discharge the same into receptacle 18. It should be appreciated, however, that the process could take place in reverse without departing from the scope of the present disclosure. During unloading, e.g. during deposition of work material transported by machine 10, conditioning apparatus 20 could be operated. In such an embodiment, sensor 60 and dispensers 34a and 34b might have their relative positions in housing 28 reversed.

Where all of the work material captured at the first work area has an optimum moisture content, or less than an optimum moisture content, machine 10 may be used to condition portions of the work material such that the entire load transported to a second work area has an optimum moisture content. In other cases, however, certain portions of the work material transported with machine 10 might be too wet. In certain embodiments, the present disclosure may allow the wet work material to be deposited at a location different from that of the work material having an optimum moisture content. During loading, work material may be initially deposited predominantly toward the bottom front of bowl 18, relatively closer to front frame unit 12. As loading progresses, work material may begin to block opening 30, and will thus be deposited in bowl 18 further from front frame unit 12, and relatively higher in bowl 18. The particular configuration and loading strategy possible with loading apparatus 21 and conditioning apparatus 20 may allow work material to be loaded in a more or less ordered fashion such that the relative location in receptacle 18 of a portion of work material having a particular moisture content will be known or at least estimable, based on sensor inputs from sensor 60 at particular times. Thus, if an initial portion of work material is determined to be too wet, an operator could deposit that portion of the work material for drying, then proceed to deposit the portion of the work material having optimum moisture content at the target deposition site, rather than delaying deposition of the entire load.

The present disclosure thus provides advantages over known scraper operating strategies, and will substantially reduce the need for in situ treatments of work material after deposition in many instances. Even in embodiments where the work material is not actually conditioned, and its relative substance content is only sensed, machine operators and site managers may be alerted to the condition of the work material prior to deposition, and may take or prepare for remedial measures in advance, offering substantial improvements in efficiency over conventional approaches.

The present description is for illustrative purposes only, and should not be construed to narrow the breadth of the present disclosure in any way. Thus, those skilled in the art will appreciate that various modifications might be made to the presently disclosed embodiments without departing from the intended spirit and scope of the present disclosure. For instance, while machine 10 has been described as having a loading apparatus 21 with an implement 22 which is an auger 22, the present disclosure is not thereby limited. Other types of scraper machines, such as elevator scrapers having loading paddles, may be fairly considered to fall within the scope of the present disclosure. Further still, as described above, machine 10 need not be a scraper machine at all, nor does it need to even consist of a single machine, as multiple machines might be used to carry out certain of the aspects of the present disclosure. In one contemplated alternative embodiment, machine 10 might be a mining conveyor configured to sense moisture content of material, and responsively add water to the same if necessary, thereby reducing dust or other undesired airborne materials. Other aspects, features and advantages will be apparent upon an examination of the attached drawings and appended claims.

What is claimed is:

1. A method of operating a scraper machine comprising the steps of:
transporting work material from a first work area to a second work area with the scraper machine;
sensing a parameter value indicative of a desired substance content in at least a portion of the work material with a sensor of the scraper machine; and
generating a signal with the sensor.

2. The method of claim 1 further comprising a step of moving work material past the sensor at least in part via a loading apparatus of the work machine.

3. The method of claim 2 wherein the sensing step comprises sensing a moisture content of at least a portion of the work material during the moving step with a moisture sensor, and wherein the step of generating a signal comprises generating a signal indicative of moisture content.

4. The method of claim 3 further comprising the steps of loading work material into a bowl of the scraper machine with the loading apparatus prior to the transporting step, and unloading work material from the bowl with the loading apparatus subsequent to the transporting step, wherein the sensing step comprises sensing a moisture content of at least a portion of the work material during at least one of the loading and unloading steps.

5. The method of claim 4 further comprising a step of conditioning at least a portion of the work material with a conditioning apparatus of the scraper machine, including dispensing a water containing fluid to the work material responsive to the sensed parameter value.

6. The method of claim 5 wherein the step of conditioning the at least a portion of the work material further comprises the steps of comparing a sensed moisture content with a desired moisture content for the work material, and dispensing a water-containing fluid from a fluid tank of the scraper machine to the work material if the sensed moisture content is less than the desired moisture content.

7. The method of claim 6 further comprising a step of determining a relative amount of water for dispensing to the work material, prior to the dispensing step, wherein the conditioning step takes place during at least one of the loading and unloading steps.

8. The method of claim 7 further comprising the steps of determining at least one of a relative loading rate and a relative unloading rate associated with the respective loading or unloading steps, and determining a timing of dispensing the water-containing fluid responsive to the determined rate.

9. The method of claim 8 wherein each of the loading and unloading steps includes rotating a feed auger of the scraper machine.

10. A method of operating a machine comprising the steps of:
transporting work material from a first work area to a second work area with the machine;
sensing a parameter value indicative of a desired substance content in at least a portion of the work material; and
conditioning at least a portion of the work material with a conditioning apparatus of the machine, including dispensing the desired substance to the work material responsive to the sensed parameter value.

11. The method of claim 10 wherein the machine comprises a scraper machine and the sensing step comprises sensing a moisture content of at least a portion of the work material with a moisture sensor of the scraper machine, the method further comprising a step of generating a sensor signal associated with the sensed moisture content.

12. The method of claim 11 further comprising a step of moving work material past the moisture sensor at least in part via a loading apparatus of the scraper machine.

13. The method of claim 12 further comprising the steps of loading work material into a bowl of the scraper machine with the loading apparatus prior to the transporting step, and unloading work material from the bowl with the loading apparatus subsequent to the transporting step, wherein the sensing step comprises sensing a moisture content of at least a portion of the work material during at least one of the loading and unloading steps.

14. The method of claim 13 wherein the step of conditioning at least a portion of the work material further comprises the steps of comparing a sensed moisture content with a desired moisture content of the work material, and dispensing a water-containing fluid to the work material responsive to the sensed moisture content, wherein the conditioning step takes place during at least one of the loading and unloading steps.

15. The method of claim 14 wherein the step of loading work material into a bowl of the scraper machine includes rotating at least one feed auger in a first direction, and wherein the step of unloading work material from the bowl includes a step of rotating the at least one feed auger in an opposite direction.

16. A scraper machine comprising:
a frame;
a substance storage tank;
a bowl; and
a work material conditioning apparatus including a substance condition sensor configured to output a signal associated with a relative content of the substance in a work material, and a substance dispenser connected to said substance storage tank and configured to selectively dispense the substance to at least a portion of work material within the scraper machine responsive to the signal.

17. The scraper machine of claim 16 further comprising a work material cutter having a cutting edge, and a work material loading apparatus separate from said work material cutter and configured to feed work material within said scraper machine.

18. The scraper machine of claim 17 wherein said work material loading apparatus includes a housing, and said substance condition sensor comprises a moisture sensor disposed at least partially within said housing.

19. The work machine of claim 18 wherein said work material loading apparatus comprises at least one feed auger, said housing extending at least partially about said at least one feed auger, and wherein said substance dispenser comprises a tip extending within said housing.

20. The work machine of claim 19 wherein said at least one loading auger comprises first and second bi-directional loading augers.
